(19) United States
(12) Patent Application Publication
(10) Pub. No.: US 2012/0033873 A1
(43) Pub. Date: Feb. 9, 2012

(54) METHOD AND DEVICE FOR DETERMINING A SHAPE MATCH IN THREE DIMENSIONS

(75) Inventors: Ryosuke Ozeki, Aichi (JP); Hironobu Fujiyoshi, Aichi (JP)

(73) Assignee: KABUSHIKI KAISHA TOYOTA JIDOSHOKKI, Aichi-ken (JP)

(21) Appl. No.: 13/264,803

(22) PCT Filed: Jun. 4, 2010
(86) PCT No.: PCT/JP2010/059540

§ 371 Date: Oct. 17, 2011

(30) Foreign Application Priority Data
Jun. 22, 2009 (JP) 2009-147561

(51) Int. Cl. G06K 9/00

(52) U.S. Cl. 382/154

(57) ABSTRACT

Provided are a method and a device for determining a shape match in three dimensions, which can utilize information relating to three-dimensional shapes effectively. Camera control means (33) of a determination device (10) captures a range image of an object as a determination target by using a range imaging camera (20). Feature point extraction means (34) extracts feature points based on the range image. Feature amount determination means (35) calculates a three-dimensional shape around the feature point as depths of surface points and determines a feature amount of the feature point based on the depths of the surface points. Match determination means (36) determines the match therebetween based on the feature amounts of the two shapes.

### TECHNICAL FIELD

The present invention relates to a method and a device for determining a shape match in three dimensions, and more particularly, to those using a feature amount for the shape.

### BACKGROUND ART

As a method for determining a shape match in three dimensions, there is known a method in which an image of a three-dimensional shape of a determination target is captured to generate a two-dimensional intensity image, thereby making a determination by using this intensity image.

For example, in the method described in Patent Document 1, an intensity distribution is acquired from an intensity image obtained by capturing an image of a three-dimensional shape, a feature amount is determined based on this intensity distribution, and a match is determined by using the determined feature amount as a reference.

Also as a method for determining a match between objects represented by two-dimensional intensity images, there is known a method of using feature amounts of the images. For example, in the methods described as “SIFT (Scale Invariant Feature Transform)” in Non-Patent Documents 1, 2, a feature point is extracted based on an intensity gradient in an intensity image, a vector representing a feature amount for the feature point is obtained, and a match is determined by using this vector as a reference.

### CITED DOCUMENTS

### Patent Document

Patent Document 1: Japanese Patent Application Laid-Open No. 2002-511175

### Non-Patent Documents

Non-Patent Document 1: Hironobu Fujiyoshi, “Gradient-Based Feature Extraction: SIFT and HOG”, Technical Report of Information Processing Society of Japan, CVIM 160, 2007, p. 211-224
Non-Patent Document 2: David G. Lowe, “Object Recognition from Local Scale-Invariant Features”, Proc. of the International Conference on Computer Vision, Corfu, September, 1999 September

### SUMMARY OF THE INVENTION

### Problem to be Solved by the Invention

However, the conventional techniques have a problem in that information related to three-dimensional shapes cannot be utilized effectively. For example, in the method described in Patent Document 1 and the methods described in Non-Patent Documents 1 and 2, only captured two-dimensional intensity images are used, so at least a part of the information related to a three-dimensional shape is lost.

A specific example in which such a problem affects determination accuracy is a case in which the surface of a determination target does not have any characteristic texture and the surface varies smoothly so that it does not have any shade. In this case, information serving as a reference for the determination cannot be obtained appropriately from intensity images.

Another specific example is a case in which angles for capturing images are different. Two-dimensional images vary significantly depending on relative position and orientation between a determination target and a camera. Consequently, even the same object produces different images if it is captured at different angles, so the match determination cannot be performed accurately. A change in an image caused by a change in three-dimensional positional relationship is beyond a mere change in rotation and scale of a two-dimensional image, so this problem cannot be solved merely by employing a method robust against changes in rotation and scale of two-dimensional images.

The present invention has been made in order to solve the above-mentioned problems, and therefore has an object to provide a method and a device which can utilize information related to a three-dimensional shape effectively upon determining a shape match in three dimensions.

### Means for Solving the Problems

According to the present invention, a method for determining a match between shapes in three dimensions includes the steps of: extracting at least one feature point for at least one shape; determining a feature amount for the extracted feature point; and based on the determined feature amount and the feature amount stored for another shape, determining a match between the respective shapes, wherein the feature amount represents a three-dimensional shape.

This method determines the feature amount representing the three-dimensional shape for the feature point extracted from the shape. The feature amount therefore contains information related to the three-dimensional shape. The match is then determined by using this feature amount. The determination of the match may be a determination as to whether or not the shapes match, or may be a determination for calculating a match value representing how well the shapes match.

The step of determining a feature amount may include the step of calculating, for each feature point, a direction of a normal line with respect to a plane including the feature point. This enables identification of the direction related to the feature point irrespective of points of view for representing the shapes.

A method according to the present invention may further comprise the steps of: extracting at least one feature point for the other shape; determining a feature amount for the feature point of the other shape; and storing the feature amount of the other shape. This enables a determination using the feature amounts determined using the same method for the two shapes.

The step of determining a feature amount may include the steps of: extracting a surface point forming a surface of the shape; identifying a projected point acquired by projecting the surface point onto the plane along the direction of the normal line; calculating a distance between the surface point and the projected point as a depth of the surface point; and calculating the feature amount based on the depth of the surface point.

The step of determining a feature amount may include the steps of: determining the scale of the feature point based on the depths of a plurality of the surface points; determining a direction of the feature point within the plane based on the depths of the plurality of the surface points; and determining a feature description region based on a position of the feature point, the scale of the feature point, and the direction of the feature point, wherein in the course of the step of calculating the feature amount based on the depth of the surface point, the feature amount is calculated based on the depths of the surface points within the feature description region.

The feature amount may be represented in the form of a vector.

The step of determining the match between the respective shapes may include the step of calculating a Euclidean distance between the vectors representing the feature amounts of the respective shapes.

At least one of the shapes may be represented by a range image.

Further, according to the present invention, a device for determining a match between shapes in three dimensions includes: range image generation means for generating a range image of the shape; storage means for storing the range image and the feature amount; and operation means for determining a match with respect to the shape represented by the range image by using the above-mentioned method.

### Effects of Invention

According to the method and device for determining a shape match in three dimensions of the present invention, information representing three-dimensional shapes is used as feature amounts and determination is made based on the feature amounts, so the information related to the three-dimensional shapes can be utilized effectively.

### BRIEF DESCRIPTION OF THE DRAWINGS

FIG. 1 is a diagram illustrating the construction of a determination device related to the present invention.

FIG. 2 is a photograph showing an exterior of an object.

FIG. 3 is a range image of the object in FIG. 2.

FIG. 4 is a flowchart explaining an operation of the determination device of FIG. 1.

FIG. 5 is a flowchart illustrating details of processes included in Step S3 and Step S7 of FIG. 4.

FIG. 6 is an enlarged view around a feature point of FIG. 1.

### DESCRIPTION OF THE EMBODIMENTS

A description is now given of embodiments of the present invention with reference to the accompanying drawings.

### First Embodiment

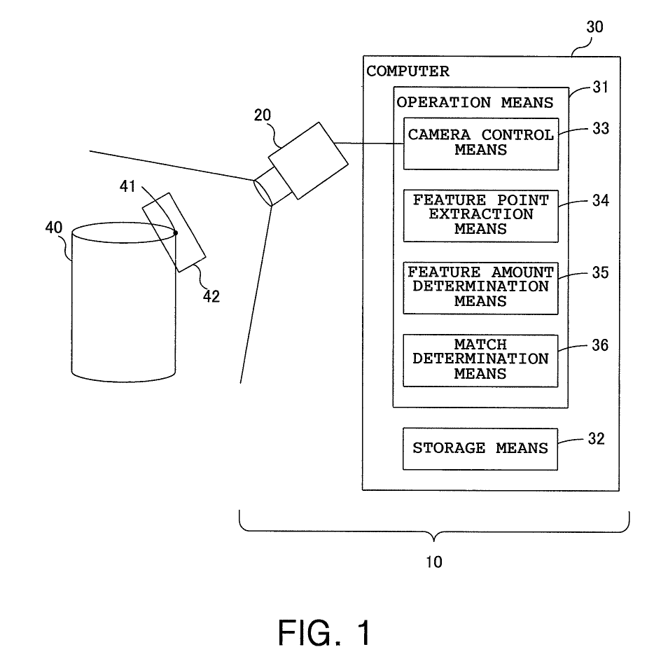

FIG. 1 illustrates the construction of a determination device 10 according to the present invention. The determination device 10 is a device for determining a shape match in three dimensions, and carries out a method for determining a shape match in three dimensions. An object 40 has a shape in three dimensions, and this shape is a target to be determined for a match in this embodiment. Here, the object 40 is a first object as a determination target.

The determination device 10 comprises a range imaging camera 20. The range imaging camera 20 is range image generation means for generating a range image representing a shape of the object 40 by capturing an image of the object 40. The range image represents information, in an image form, for each point included in the object or a surface thereof within an image-capturing area of the range imaging camera 20, representing respective distances between the range imaging camera 20 and the points.

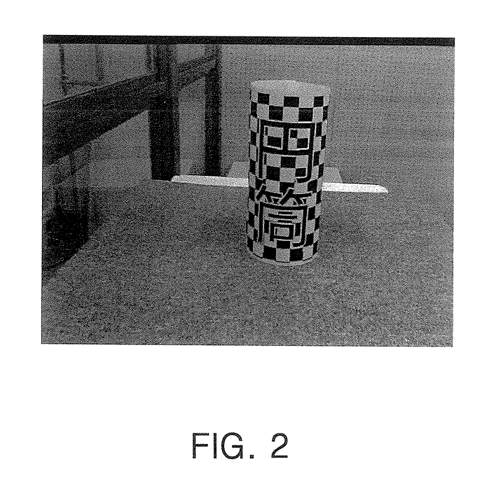

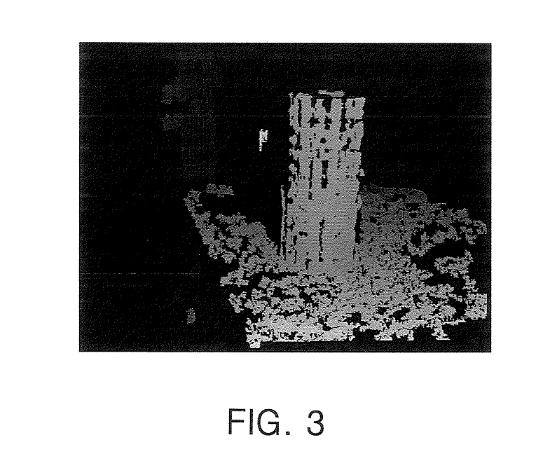

FIG. 2 and FIG. 3 are figures for contrasting an exterior and a range image of the same object. FIG. 2 is a photograph showing an exterior of a cylindrical object on which the characters for cylinder “ [symbol] ” are written, and is an intensity image. FIG. 3 is an image obtained by capturing an image of this object by using the range imaging camera 20, and is a range image. In FIG. 3, portions shorter in distance from the range imaging camera 20 are represented brighter, and portions longer in distance are represented darker. As can be seen from FIG. 3, the range image represents distances to respective points forming the shape of the object surface irrespective of textures (such as the characters for cylinder “ [symbol] ” on the object surface).

As illustrated in FIG. 1, a computer 30 is connected to the range imaging camera 20. The computer 30 is a computer having a well-known construction and is constituted by a microchip, or a personal computer, etc.

The computer 30 comprises operation means 31 for executing operations, and storage means 32 for storing information. The operation means 31 is for example a well-known processor and the storage means 32 is for example a well-known semiconductor memory device or magnetic disk device.

The operation means 31 executes a program integrated into the operation means 31 or a program stored in the storage means 32 so that the operation means 31 functions as camera control means 33 for controlling an operation of the range imaging camera 20, feature point extraction means 34 for extracting a feature point from a range image, feature amount determination means 35 for determining a feature amount for the feature point, and a match determination means 36 for determining a shape match. Details of these functions will be explained later.

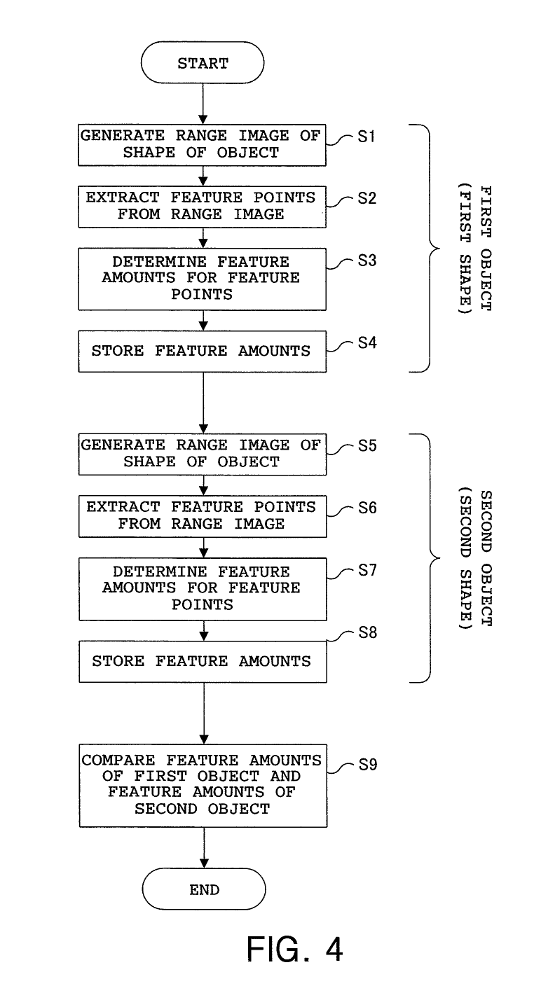

Description is now given of an operation of the determination device 10 illustrated in FIG. 1 with reference to the flowchart illustrated in FIG. 4.

First, the determination device 10 performs an operation for the object 40 as a first object having a first shape (Steps S1 to S4).

The determination device 10 first generates a range image representing a shape of the object 40 (Step S1). In Step S1, the camera control means 33 controls the range imaging camera 20, thereby causing the range imaging camera 20 to capture the range image, receives data of the range image from the range imaging camera 20, and stores the data in the storage means 32. In other words, the storage means 32 stores the data of the range image such as illustrated in FIG. 3.

The determination device 10 then extracts at least one feature point for the shape of the object 40 based on the range image thereof (Step S2). Step S2 is executed by the feature point extraction means 34.

This feature point may be extracted by means of any method, and an example is described below. The range image is a two-dimensional image, so from the viewpoint of format, the range image can be viewed as data having the same construction as a two-dimensional intensity image, if distance is interpreted as intensity. In other words, in the example illustrated in FIG. 3, a closer point is represented as a point having higher intensity, and a farther point is represented as a point having lower intensity, and the representation by means of intensity can be directly used as an intensity image. As a result, a well-known method for extracting a feature point from a two-dimensional intensity image can be applied directly as a method for extracting a feature point for the shape of the object 40.

A large number of methods for extracting a feature point from a two-dimensional intensity image are well known, and any of them may be used. For example, a feature point may be extracted by using a method according to the SIFT described in Non-Patent Documents 1 and 2. In other words, in this case, the feature point extraction means 34 extracts a feature point from the range image of the object 40 by means of the method according to the SIFT. In the method according to the SIFT, convolution of a Gaussian function and an intensity image (i.e. the range image in this embodiment) is carried out while changing the scale of the Gaussian function, differences in intensity (range) of respective pixels due to the change in scales are calculated based on results of the convolution, and a feature point is extracted corresponding to a pixel which becomes the most extreme in difference.

In the following example, a feature point 41 illustrated in FIG. 1 is extracted. By taking the feature point 41 as an example, a description is given of Steps S3 and S4 as follows. If a plurality of feature points are extracted, processes of Steps S3 and S4 are executed for each of the feature points.

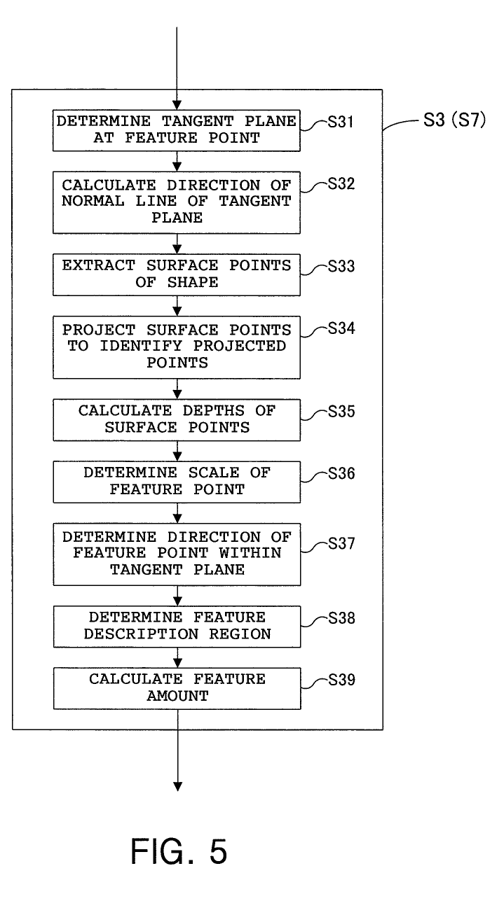

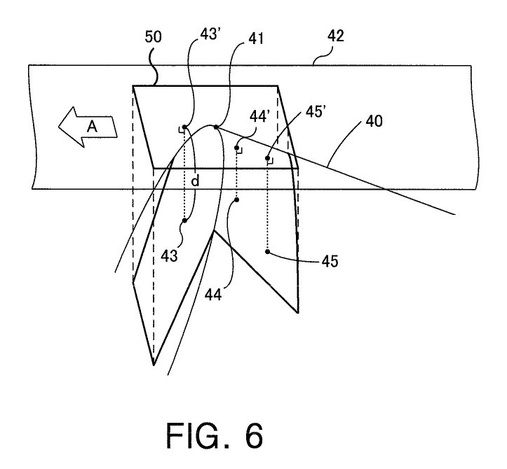

The determination device 10 determines a feature amount for the feature point 41 (Step S3). This feature amount represents a three-dimensional shape of the object 40. A detailed description is given of the process of Step S3 referring to FIG. 5 and FIG. 6.

FIG. 5 is a flowchart illustrating details of processes contained in Step S3, and FIG. 6 is an enlarged view around the feature point 41 in FIG. 1.

In Step S3, the feature amount determination means 35 first determines a plane including the feature point 41 (Step S31). For example, this plane may be a tangent plane 42 in contact with the surface of the object 40 at the feature point 41.

Also, in Step S3, the feature amount determination means 35 then calculates the direction of a normal line of the tangent plane 42 (S32).

The range image contains information representing the shape of the feature point 41 and around it, so those skilled in the art can design an operation for calculating the tangent plane 42 and the direction of the normal line thereof as needed in Steps S31 and S32. In this way, the direction related to the shape at the feature point 41 can be identified irrespective of positions or angles of the range imaging camera 20.

Then, for the shape of the surface of the object 40, the feature amount determination means 35 extracts points forming the surface as surface points (Step S33). The surface points can be extracted for example by selecting grid points at regular intervals within a predetermined area, but the surface points may be extracted using any method as long as the method extracts at least one surface point. In the example of FIG. 6, surface points 43 to 45 are extracted.

The feature amount determination means 35 then identifies a projected point corresponding to each surface point (Step S34). The projected point is identified as a point obtained by projecting the surface point onto the tangent plane 42 along the direction of normal line of the tangent plane 42. In the example of FIG. 6, projected points corresponding to the surface points 43 to 45 are referred to as projected points 43′ to 45′ respectively.

The feature amount determination means 35 then calculates a depth for each surface point (Step S35). The depth is calculated as a distance between the surface point and its corresponding projected point. For example, the depth of the surface point 43 is represented by d.

The feature amount determination means 35 then determines the scale of the feature point 41 based on the depths of the surface points (Step S36). The scale is a value representing the size of a characteristic area within the shape around the feature point 41.

In Step S36, the scale of the feature point 41 may be determined by any method, and an example is described below. Each projected point can be represented by two-dimensional coordinates on the tangent plane 42, and the depth of the surface point corresponding to respective projected point is a scalar value. As a result, from the viewpoint of format, if the depth is interpreted as intensity, the depths can be viewed as data having the same construction as a two-dimensional intensity image. In other words, the data representing the depths of the projected points can be directly used as an intensity image. As a result, as a method for determining the scale of the feature point 41, any well-known method for determining a scale of a feature point in a two-dimensional intensity image can be applied directly.

As the method for determining the scale of a feature point in a two-dimensional intensity image, a method according to the SIFT described in Non-Patent Documents 1 and 2 may be used. In other words, in this case, the feature amount determination means 35 determines the scale of the feature point 41 based on the depths of the surface points and by using the method according to the SIFT.

By using the method according to the SIFT, the size of the characteristic area can be taken into account as the scale, so the method according to this embodiment is robust against variation in size. Specifically, if an apparent size of the object 40 (i.e. distance between the object 40 and the range imaging camera 20) changes, the scale also changes in response to this, so a shape match can be determined accurately taking the apparent size into account.

The feature amount determination means 35 then determines a direction (or orientation) of the feature point 41, within the tangent plane 42, based on the depths of the surface points (Step S37). This direction is a direction orthogonal to the direction normal to the tangent plane 42. In the example of FIG. 6, we assume that the direction of the feature point 41 is determined to be direction A.

In Step 37, the direction of the feature point 41 may be determined by using any method, and a method according to the SIFT described in Non-Patent Documents 1 and 2 may be used as in Step S36. In other words, the feature amount determination means 35 determines the direction of the feature point 41 within the tangent plane 42 based on the depths of the surface points by using the method according to the SIFT. In the method according to the SIFT, an intensity gradient is calculated for each pixel (in this embodiment, a depth gradient is calculated for each surface point), a convolution of the gradient and a Gaussian function centered at the feature point 41 according to the scale is carried out, results of the convolution are represented in a histogram having bins for discretized directions, and a direction giving the largest gradient in the histogram is determined as the direction of the feature point 41.

Although only the direction A is given as the direction of the feature point 41 in the example illustrated in FIG. 6, one feature point may have a plurality of directions. According to the SIFT, a plurality of directions giving respective extrema exceeding a predetermined value of depth gradient may be acquired. However, also in such cases, the following operation can be carried out in the same manner.

By using the method according to the SIFT, the direction A can be identified within the tangent plane 42 and the feature amount can be described with coordinate axes aligned to the direction A, making the method according to this embodiment robust against rotation. Specifically, if the object 40 rotates within the field of view of the range imaging camera 20, the direction of the feature point also rotates in response to this, so the method can obtain a feature amount substantially invariant to the direction of the object and can determine a shape match accurately.

The feature amount determination means 35 then determines a feature description region 50 related to the feature point 41 (Step S38) based on the position of the feature point 41 extracted in Step S2, the scale of the feature point 41 determined in Step S36 and the direction of the feature point 41 determined in Step S37. The feature description region 50 is an area defining an extent of coverage for the surface points to be considered in determining the feature amount of the feature point 41.

The feature description region 50 may be determined in any way as long as the feature description region 50 is determined uniquely according to the position of the feature point 41, the scale of the feature point 41 and the direction of the feature point 41. For example, if a square area is used, the feature description region 50 can be determined within the tangent plane 42 by placing the square centered at the feature point 41, the length of one side of the square being set according to the scale and the direction of the square determined according to the direction of the feature point 41. Also, if a circular region is used, the feature description region 50 can be determined within the tangent plane 42 by placing the circle centered at the feature point 41, the radius being set according to the scale and the direction of the circle determined according to the direction of the feature point 41.

Note that, the feature description region 50 may be determined within the tangent plane 42 as illustrated in FIG. 6, or may be determined on a surface of the object 40. In any case, the surface points and the projected points included in the feature description region 50 can be determined equivalently by projecting the feature description region 50 in a tangent direction between the tangent plane 42 and the object 40.

The feature amount determination means 35 then calculates a feature amount of the feature point 41 based on the depths of the surface points included in the feature description region 50 (Step S39). In Step S39, the feature amount of the feature point 41 may be calculated using any method, and a method according to the SIFT described in Non-Patent Documents 1 and 2 may be used as in Steps S36 and S37. In other words, in this case, the feature amount determination means 35 calculates the feature amount of the feature point 41 based on the depths of the surface points by using the method according to the SIFT.

The feature amount can be represented in a vector form. For example, in the method according to the SIFT, the feature description region 50 is divided into a plurality of blocks, and a histogram of the depth gradient having bins for a predetermined number of discretized directions for every block can be set as the feature amount. For example, if the feature description region 50 is divided into 4×4 (total of 16) blocks and the gradient is discretized into eight directions, the feature amount will be a vector in 4×4×8=128 dimensions. The calculated vector may be normalized. This normalization may be carried out so that the sum of lengths of the vectors for all the feature points remains a constant value.

Step S3 is thus carried out and the feature amount is determined. Here, the depths of the surface points represent a three-dimensional shape of the object 40, so it can be said that the feature amount is calculated based on a three-dimensional shape within the feature description region 50.

The determination device 10 then stores the feature amount in the storage means 32 (Step S4 in FIG. 4). This operation is carried out by the feature amount determination means 35. The operation for the object 40 completes at this point.

The determination device 10 then carries out an operation similar to that of Steps S1 to S4 for a second object having a second shape (Steps S5 to S8). Processes in Steps S5 to S8 are similar to those in Steps S1 to S4, so detailed explanation is omitted.

The determination device 10 then makes a determination for a match between the first shape and the second shape based on the feature amount determined for the first shape and the feature amount determined for the second shape (Step S9). The match determination means 36 makes a determination for the match in Step S9. The determination for the match may be made in any way, and an example is described below.

In the determination method described herein as an example, the feature points are first associated with each other by using a kD tree. For example, all the feature points are sorted into a kD tree having n levels where n is an integer. Then, by means of the best-bin-first method using the kD tree, for each feature point of one shape (e.g. the first shape), the most similar feature point is retrieved out of the feature points of the other shape (e.g. the second shape), and these feature points are associated with each other. In this way, each feature point of one shape is associated with the respective feature point of the other shape so that pairs of the feature points are generated.

At this point, the pairs may include pairs of feature points which do not actually correspond (i.e. pairs of false association). A method called RANSAC (RAndom SAmple Consensus) is used in order to eliminate these pairs of false association as outliers. RANSAC is described in a paper titled “Random Sample Consensus: A paradigm for model fitting with applications to image analysis and automated cartography” by M. Fischer and R. Bolles (Communications of the ACM, Vol. 24, No. 6, pp. 381-385, 1981).

In RANSAC, a group is first generated by selecting a predetermined number N1 of pairs randomly among the pairs of the feature points, and a homography transformation from vectors of the feature points of one shape to vectors of the feature points of the other shape is obtained based on all the selected pairs. Then, for each pair in the group, a Euclidean distance between the resulting vector obtained by applying the homography transformation to the vector representing the feature point of the one shape and the vector of the feature point of the other shape is obtained. If the distance of a pair is equal to or less than a predetermined threshold D, the pair is determined to be an inlier, i.e. a correct association. If the distance of the pair exceeds the predetermined threshold D, the pair is determined to be an outlier, i.e. a false association.

After that, another group is generated by selecting the predetermined number N1 of pairs randomly again and each pair is determined as to whether it is an inlier or an outlier similarly for this other group. In this way, the generation of groups and the determination are repeated for a predetermined number of times (X times), and a group which gives the largest number of pairs determined to be inliers is identified. If a number N2 of the inliers included in the identified group is equal to or larger than a threshold N3, it is determined that the two shapes match. If N2 is less than N3, it is determined that the two shapes do not match. Alternatively, a match value representing how well the two shapes match may be determined according to the value of N2.

Note that those skilled in the art can determine appropriate values experimentally for the parameters in the above-mentioned method, i.e. N1, N2, N3, D and X.

As described above, according to the determination device 10 of the first embodiment of the present invention, the three-dimensional shape or relief of a surface is represented using the depths of surface points, and feature points and feature amounts are determined based on them. The determination device 10 then determines a shape match between three-dimensional shapes based on the feature points and feature amounts. Therefore, information related to the three-dimensional shapes can be utilized effectively for the determination.

For example, even if a surface of an object as a determination target does not have any characteristic texture and the surface varies smoothly so that it has no shade, the depths can be calculated according to the varying surface and the match can be determined appropriately.

Moreover, even if the angles upon capturing the images are different, a match can be determined appropriately. The shape does not change for the same object even if the angle for capturing the image changes, so the same feature point has invariant normal line direction and invariant depth gradient, resulting in an invariant feature amount. Therefore, as long as common feature points are included in the respective range images, correspondence between the feature points can be detected appropriately according to correspondence between feature amounts.

Moreover, the present invention can cope with a change in the viewpoint with respect to the object, so there is no restriction on the orientation or the position of the object and the present invention can be applied to a wide variety of usages. Further, the determination can be made with reference to a range image from a single viewpoint, so it is not necessary to store range images from a large number of viewpoints in advance, resulting in a reduction of memory usage.

In the first embodiment described above, only three-dimensional shapes (depths of surface points) are used for determining feature amounts. However, information related to textures may additionally be used. In other words, an image serving as the input may contain information representing intensity (either monochrome or colored) in addition to information representing the range. In this case, feature amounts related to the intensity can be calculated by using a method according to the SIFT. It is possible to improve accuracy of the determination by determining the match based on a combination of the feature amounts related to the three-dimensional shapes acquired according to the first embodiment and the feature amounts related to the intensity.

In the first embodiment, extraction of feature points and determination of feature amounts are based entirely on range images. Alternatively, these operations may be carried out based on information other than the range image. This additional information may be anything that can be used for extracting the feature points and calculating the depths, such as a solid model. Also, a similar operation can be carried out for what does not exist as a real object.

### Second Embodiment

In the first embodiment described above, the determination device captures respective images of two shapes in order to determine the feature amounts. In the second embodiment, the feature amounts for the first shape are stored in advance, and images are captured and feature amounts are determined only for the second shape.

The operation of the determination device according to the second embodiment is the operation of FIG. 4 wherein Steps S1 to S3 are omitted. In other words, the determination device does not determine any feature amount for the first shape, and, instead, receives feature amounts determined externally (e.g. by another determination device) as an input and stores the feature amounts. This process corresponds for example to inputting model data. An operation subsequent to Step S4 is similar to that of the first embodiment. That is, the determination device captures an image, extracts feature points and determines feature amounts for the second shape, and then determines the match between the first shape and the second shape.

The second embodiment is suitable for an application wherein common model data is prepared on all determination devices and only objects (shapes) matching the model data are selected. If the model data needs to be changed, it is not necessary for all the determination devices to capture an image of a new model, but any one of the determination devices may determine feature amounts of the model and then data of the feature amounts may be copied to the other determination devices. Thus, efficiency of the work is improved.

1. A method for determining a match between shapes in three dimensions, comprising the steps of:
extracting at least one feature point for at least one of the shapes;
determining a feature amount for the extracted feature point; and
based on the determined feature amount and a feature amount stored for another shape, determining a match between the respective shapes, wherein
the feature amount represents a three-dimensional shape.

2. A method according to claim 1, wherein the step of determining the feature amount comprises a step of calculating, for each of the at least one feature point, a direction of a normal line with respect to a plane including the feature point.

3. A method according to claim 1, further comprising the steps of:
extracting at least one feature point for the other shape;
determining a feature amount for the feature point of the other shape; and
storing the feature amount of the other shape.

4. A method according to claim 2, wherein the step of determining the feature amount comprises the steps of:
extracting a surface point forming a surface of the shape;
identifying a projected point acquired by projecting the surface point onto the plane along a direction of normal line;
calculating a distance between the surface point and the projected point as a depth of the surface point; and
calculating the feature amount based on the depth of the surface point.

5. A method according to claim 4, wherein the step of determining a feature amount comprises the steps of:
determining a scale of the feature point based on the depths of a plurality of the surface points;
determining a direction of the feature point within the plane based on the depths of the plurality of the surface points; and
determining a feature description region based on a position of the feature point, the scale of the feature point and the direction of the feature point, wherein
in the course of the step of calculating the feature amount based on the depth of the surface point, the feature amount is calculated based on the depths of the surface points within the feature description region.

6. A method according to claim 1, wherein the feature amount is represented in a form of a vector.

7. A method according to claim 6, wherein the step of determining the match between the respective shapes comprises the step of calculating a Euclidean distance between the vectors representing the feature amounts of the respective shapes.

8. A method according to claim 1, wherein at least one of the shapes is represented by a range image.

9. A device for determining a match between shapes in three dimensions, comprising:
range image generation means for generating a range image of the shape;
storage means for storing the range image and the feature amount; and
operation means for determining a match with respect to the shape represented by the range image by using the method according to claim 1.
